(19) United States
(12) Patent Application Publication
(10) Pub. No.: US 2024/0227125 A1
(43) Pub. Date: Jul. 11, 2024

(54) A PARTICULATE MATERIAL BLASTING APPARATUS

(71) Applicant: SWISS INDUSTRIAL CONSULTING & TECHNOLOGY SA, Morges (CH)

(72) Inventor: Nicolas GANSHOF VAN DER MEERSCH, Morges (CH)

(73) Assignee: SWISS INDUSTRIAL CONSULTING & TECHNOLOGY SA, Morges (CH)

(21) Appl. No.: 18/559,149

(22) PCT Filed: May 5, 2022
(86) PCT No.: PCT/EP2022/062228

§ 371 Date: Nov. 6, 2023

(30) Foreign Application Priority Data
May 5, 2021 (GB) 2106398.7

(51) Int. Cl. B24C 7/00; B05B 7/14

(52) U.S. Cl. CPC B24C 7/0076; B05B 7/1404

(57) ABSTRACT

A particulate material blasting apparatus includes a particulate material dosing device, a particulate material storage tank having a base, top and sidewalls adapted to feed particulate material to the dosing device, and a delivery conduit to deliver particular material into a pressurized gas line. The dosing device includes a rotor with a series of scooping pockets mounted along a circumference of the rotor configured to rotate to scoop-up particular material from a particulate material receiving side of the dosing device and deliver it up and around to a delivery side of the dosing device where it falls into the delivery conduit.

### FIELD

The present invention relates to a particulate material blasting apparatus. Also contemplated are methods of blasting a surface with particulate material.

### BACKGROUND

Dosing devices for non-abrasive blasting are known and generally comprise a product feed conduit, a dosing chamber for metering the blasting media, and a pressurised fluid line into which the metered media is dosed. The mixture of metered media and fluid are fed under pressure to a dispensing nozzle. Conventional dosing systems use a pressure differential to meter the amount of media charged into the fluid. An advantage of such a system is that it can be used with both abrasive and non-abrasive material; a disadvantage is that the accuracy of dosing is poor. In an attempt to address the dosing accuracy problem, the Applicant devised a dosing device comprising a spinning disk with a hole, wherein media is dosed when the hole rotates into register with media feed and supply conduits. An example of such a device is described in U.S. Pat. No. 6,896,197. With this type of device, a seal is required between spinning disk and the plates between the disk is mounted to prevent seepage of media when the disk is not operational. As the adjustment between the disk and the plates has to be very small, the seal is rapidly destroyed due to the friction between the disks and the plates; this problem is exacerbated by the media which has an abrasive effect on the disks and plates, resulting in the device only being usable with non-abrasive material.

U.S. Pat. No. 3,758,004 describes a dosing device for particulate material having a dosing chamber within which is mounted a rotatable rotor for delivery of particulate material into a dispensing outlet. The device is designed with very close tolerances between the periphery of the rotor and the walls of the dosing chamber to avoid passage of particulate material into the dispending outlet when the rotor is not turning. Such close tolerances cause friction and wear on the adjacent surfaces of the rotor and the dispensing chamber, which problems are exacerbated by any media which falls into tight gaps between the surfaces.

It is an objective of the invention to provide an improved seat-table.

EP0652078 describes a device for feeding particles into a flow of air. The device illustrated in FIGS. 27 to 29 comprises a hopper, a particulate material discharge area disposed on one side of a base of the hopper, and an inlet of a nozzle disposed in the discharge area which draws the particulate material into the flow of air in the nozzle. The discharge area and hopper are separated by a rotary valve which rotates counter-clockwise (FIG. 27) to pull material down and around and into the discharge area. The rotary valve acts as a stop to prevent material flowing into the discharge area, and this requires very close tolerances between the rotary valve and the housing which are prone to being clogged with particulate material.

JP H0994765 describes a dosing device for particulate material having a hopper 12 to store material and a dosing device 2 that is separate to the hopper and connected thereto by a conveying tube 15. The dosing device comprises a rotating wheel with pockets that lift up particulate material to an outlet tube disposed above the wheel which suck particulate material up into the outlet tube. The device is bulky and has separate parts which complicates manufacture. As the hopper tank is pressurised, large pressure gradients are generated across the wall of the tank which requires the tank to be made from a strong material. In addition, a pressure equalisation conduit (23 in FIGS. 1 and 2) is required to balance pressure between the pressurised storage tank and the dosing device.

WO2007/107322 describes a dosing device for particulate material and blasting apparatus. Referring to FIGS. 1 and 5 of WO2007/107322, the dosing device has a dosing chamber with a material receiving side, a material dispensing side, and a rotor interposed between the dispensing and receiving sides. Material is delivered onto a base of the material receiving side by a feed conduit from the pressurised storage tank, and rotation of the rotor lifts the material up (typically in a scooping action) from the receiving side and delivers it to the delivery side of the dosing chamber. The base of the material receiving side is disposed with respect of the feed conduit such that particulate material will not spill into the delivery side of the dosing chamber when the rotor is static. This enables the device to be made without close tolerances between the rotor and the adjacent walls of the dosing chamber, thereby minimising wear and tear on these components. As the tank is pressurised, large pressure gradients are generated across the wall of the tank which requires the tank to be made from a strong material. In addition, a pressure equalisation conduit (29 in FIG. 5) is required to balance pressure between the pressurised storage tank and the dosing device.

It is an object of the invention to provide a simpler particulate material blasting apparatus.

### SUMMARY

The objective is met by the provision of a blasting apparatus in which the dosing device is located inside the pressurised storage reservoir, thus removing the pressure gradient between the dosing device and the storage reservoir and the dosing device and obviating the requirement for a pressure balancing conduit. In addition, as the dosing device and particulate material (media) are contained within the storage reservoir, the walls of the storage reservoir do not have to endure large pressure gradients and may be made of cheaper, thinner materials. This arrangement also allows the delivery conduit to function as a pressure equalisation conduit.

In a first aspect, the invention provides a particulate material blasting apparatus comprising a particulate material dosing device, a particulate material storage tank adapted to feed particulate material to the dosing device, and a delivery conduit to deliver particular material into a pressurised gas line. Typically, the delivery conduit has an upper part comprising a first inlet aperture disposed in the particulate material storage tank and a lower part comprising an outlet disposed outside the particulate material storage tank. The delivery conduit is generally disposed vertically (or nearly vertically) with respect to the base of the storage tank so that particulate material falls from the inlet to the outlet easily and under the force of gravity. The tank generally has a base, top and sidewalls. The dosing device comprises a rotor comprising a series of scooping pockets mounted along a circumference of the rotor configured to rotate to scoop-up particular material from a particulate material receiving side of the rotor and deliver it up and around to a delivery side of the rotor where it falls into the delivery conduit through the inlet and falls downwardly into a pressurised gas line. The dosing device is located in the particulate material storage tank and the delivery conduit comprises an outlet disposed outside the particulate material storage tank.

In any embodiment, the first inlet aperture of the delivery conduit is disposed adjacent the base of the particulate material storage tank, wherein the rotor is mounted partly within the first inlet aperture such that a particulate material receiving side of the rotor is disposed outside the aperture and a particulate material receiving side of the rotor is disposed inside the aperture. Thus, the dosing device does not require its own housing and the base of the tank functions as the base of the dosing device.

In any embodiment, the delivery conduit comprises a second inlet aperture disposed toward a top of the particulate material storage tank. This inlet allows the delivery conduit to also function as a pressure equalisation conduit and normalise pressure between the top and bottom of the pressurised tank.

In any embodiment, the dosing device comprises a baffle attached to the delivery conduit dimensioned to curve around and cover a top (and preferably the sides) of the particulate material receiving side of the rotor. This serves to guide particulate material away from the top of the rotor and towards the material receiving side of the rotor, preventing the rotor becoming clogged with material.

In any embodiment, the apparatus comprises a bearing, gearbox and a motor for the rotor.

In any embodiment, the bearing, gearbox and optionally the motor are contained within a sealed housing coupled to the base of the particulate material storage tank.

In any embodiment, the outlet of the delivery conduit is configured for fluidically coupling to a pressurised gas line. In any embodiment, the outlet of the delivery conduit comprises a T-coupling with an inlet configured for fluidic coupling to a pressurised gas line and an outlet configured for coupling to a blasting nozzle conduit.

In any embodiment, the delivery conduit is disposed with respect to the particulate material storage tank such that particulate material flows downwardly from the first inlet inside the tank towards the outlet outside the tank under the force of gravity

In any embodiment, the top of the particulate material storage tank includes a fitting for receiving a top of the delivery conduit and securing the delivery conduit in position (e.g., disposed vertically) within the particulate material storage tank.

In embodiment, the rotor is coupled to the particulate material storage tank so as to provide a clearance between the rotor and the base of the tank while still be positioned to scoop up material sitting on the base of the tank.

In embodiment, the rotor is coupled to the particulate material storage tank so as to provide a clearance between the rotor and the base of the tank of about 0.1 to about 2 cm, about 0.1 to about 1.0 cm, about 0.2 to about 0.6 cm.

In any embodiment, the rotor is mounted in the aperture of the delivery conduit such that an axle of the rotor is perpendicular with a longitudinal axis of the delivery conduit.

In any embodiment, the rotor is mounted in the aperture of the delivery conduit such that an axle of the rotor is in line with a sidewall of the delivery conduit.

In any embodiment, the delivery conduit and particulate material storage tank each comprise a cylindrical pipe.

In any embodiment, the delivery conduit has a diameter that is about 10-25% of a diameter of the particulate material storage tank.

In any embodiment, the rotor comprises at least two series of scooping pockets mounted along the circumference of the rotor, and in which the pockets of one series are circumferentially staggered with respect to the pockets of the other series.

In any embodiment, the dosing device comprises a plurality of rotors, in which the scooping pockets of one rotor are typically circumferentially staggered with respect to those of the other rotor.

In any embodiment, the pockets are formed by tooth-like formations which project from the circumference of the rotor.

In any embodiment, the apparatus of the invention comprises a pressurised fluid line. In any embodiment, the apparatus comprises a nozzle fluidically connected to the pressurised fluid line. In any embodiment, the apparatus comprises a motor configured to provide pressurised fluid to the pressurised fluid line.

In another aspect, the invention provides a method of blasting a surface with particulate material which employs a particulate material blasting apparatus according to the invention.

The method typically comprises the steps of:
providing a reservoir of particulate material in the particulate material storage tank;
actuating a motor to rotate the rotor at a desired speed corresponding to the desired material dosing rate, and dosing particulate material through the delivery conduit into a pressurised gas line disposed externally to the storage reservoir; and
blasting a surface by employing a nozzle fluidically coupled to the pressurised gas line to direct a stream of pressurised gas and particulate material at the surface.

Other aspects and preferred embodiments of the invention are defined and described in the other claims set out below.

### BRIEF DESCRIPTION OF THE FIGURES

FIG. 1 (Prior art) shows a particulate material blasting apparatus of the prior art.

FIG. 2 shows a particulate material blasting apparatus of the invention.

### DETAILED DESCRIPTION

All publications, patents, patent applications and other references mentioned herein are hereby incorporated by reference in their entireties for all purposes as if each individual publication, patent or patent application were specifically and individually indicated to be incorporated by reference and the content thereof recited in full.

Where used herein and unless specifically indicated otherwise, the following terms are intended to have the following meanings in addition to any broader (or narrower) meanings the terms might enjoy in the art:

Unless otherwise required by context, the use herein of the singular is to be read to include the plural and vice versa. The term “a” or “an” used in relation to an entity is to be read to refer to one or more of that entity. As such, the terms “a” (or “an”), “one or more,” and “at least one” are used interchangeably herein.

As used herein, the term “comprise,” or variations thereof such as “comprises” or “comprising,” are to be read to indicate the inclusion of any recited integer (e.g. a feature, element, characteristic, property, method/process step or limitation) or group of integers (e.g. features, element, characteristics, properties, method/process steps or limitations) but not the exclusion of any other integer or group of integers. Thus, as used herein the term “comprising” is inclusive or open-ended and does not exclude additional, unrecited integers or method/process steps.

### Exemplification

The invention will now be described with reference to specific Examples. These are merely exemplary and for illustrative purposes only: they are not intended to be limiting in any way to the scope of the monopoly claimed or to the invention described. These examples constitute the best mode currently contemplated for practicing the invention.

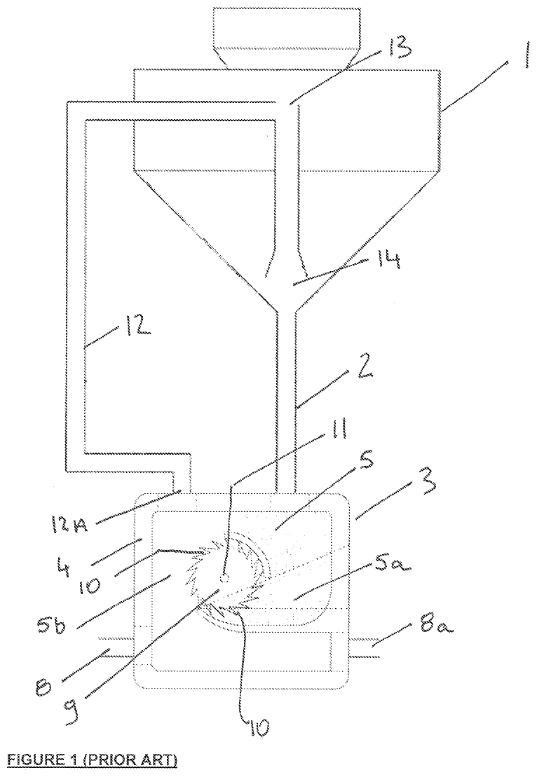

Referring initially to FIG. 1 (Prior art), a particulate material blasting apparatus of WO2007/107322 is described and comprises a media tank 1 with a gravity flow media outlet 2 feeding into a dosing device 3. The dosing device comprises a housing 4 defining a dosing chamber 5 with a product receiving side 5a and a product delivery side 5b, a product feed conduit 6, and a product delivery conduit 7. The product delivery conduit 7 feeds into a pressurised air supply line 8 which forms a product outlet 8a. Although not shown in the Figures, the product outlet line 8a feeds into a dispensing nozzle. In more detail, a rotor 9 having a plurality of circumferentially formed pockets 10 is rotatably mounted within the dosing chamber 3. Each pocket 10 is formed by a tooth-like formation which extends from a circumference of the rotor 9. The rotor 9 includes an axle 11 which engages with a motor (not shown) for rotation of the rotor 9. The speed of rotation of the rotor 9 may be decided by the operator according to the blasting conditions required. A pressure equalisation conduit 12 is provided between an opening 12A in a top of the product delivery side 5b of the dosing chamber and the top 13 and bottom 14 of the media tank 1.

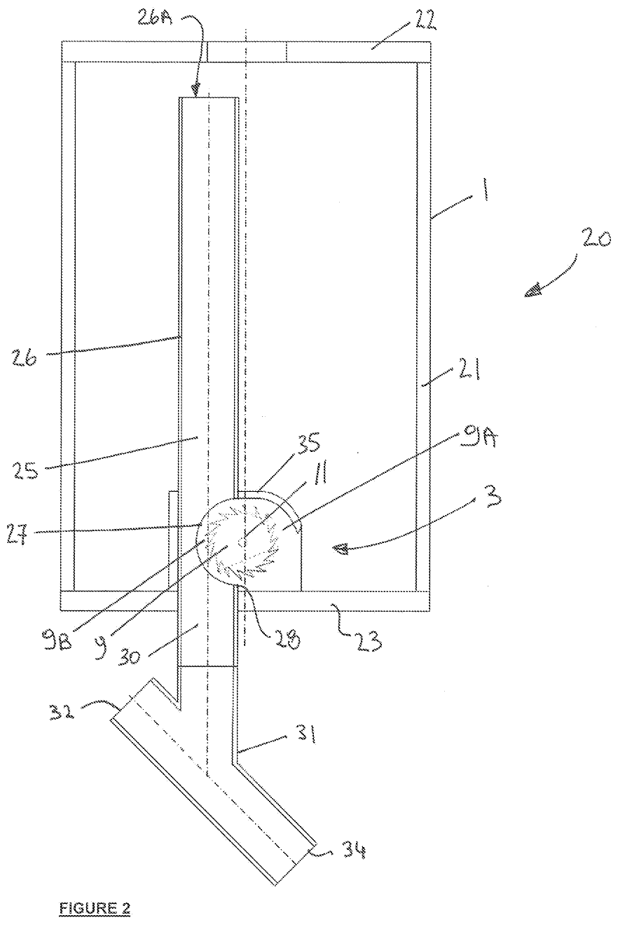

Referring to FIG. 2, the blasting apparatus of the invention, indicated generally by the reference numeral 20, is described in which parts described previously are assigned the same reference numerals. The blasting apparatus comprises a particulate material storage tank 1 having a cylindrical sidewall 21 formed of DN100 stainless steel, a top wall 22, a bottom wall 23, and a dosing device 3 inside the tank. The bottom wall (flange) may be formed of cast aluminium. In use the tank is pressurised with sealing O-rings (not shown) provided at the top and bottom to seal with top and bottom walls to the sidewall. The top also includes an opening with a door (not shown) allowing the tank to be filled with media without having to remove the top wall and a fill-level sensor.

The dosing device 3 is comprised of a rotor 9, having a media receiving side 9A and a media delivery side 9B. The apparatus 20 also comprises a delivery conduit 25. The delivery conduit has an upper part within the tank and a lower part outside the tank. The upper part comprises an elongated pipe 26 disposed vertically and slightly asymmetrically within the tank 1 such that a top of the pipe 26 is disposed adjacent the top wall 22 of the tank and has an inlet aperture 26A. The pipe has a circular aperture 27 disposed adjacent the bottom wall 23 of the tank, and the rotor is mounted to the bottom wall 23 of the tank such that the media receiving side 9A of the rotor 9 is disposed outside the pipe 26 and the media delivery side 9B of the rotor 9 is disposed inside the pipe 26, with a clearance between the rotor 9 and bottom wall 23 of the tank 1 of about 0.2 cm to 0.6 cm. The aperture 27 is positioned in the delivery pipe just above the bottom wall 23 so as to provide a lip 28 above the bottom wall. This helps prevent media falling into the delivery conduit when the rotor is static. A curved baffle 35 is attached to the delivery conduit 25 just above the aperture 27 so as to cover a top and sides of the media receiving side 9A of the rotor 9 and guide material towards a material receiving side of the dosing device and prevent material falling into the delivery conduit when the rotor is static. As shown in FIG. 2, the axle 11 of the rotor is positioned in-line with the sidewall of the delivery conduit 25 and generally perpendicular with a longitudinal axis of the delivery conduit 25. Although not illustrated, the tank comprises a sealed housing disposed on each side of the rotor for holding the bearings and gearing of the rotor and the motor.

The lower part of the delivery conduit 25 passes through a sealed aperture in the bottom wall 23 and has an outlet 30 that is coupled to a pressurised line by a T-fitting 31 with an inlet 32 configured for fluidic coupling with a pressurised gas line (not shown) and an outlet 34 configured for coupling to a nozzle line (not shown).

Although not illustrated, the rotor has the same construction as that illustrated in WO2007/107322 with three axially aligned rotors each having a series of scooping pockets configured to pick up material from a media receiving side of the dosing device and deliver media up and around to a material delivery side of the dosing device where it falls into the delivery conduit.

In use, a particulate material such as particles of agglomerated calcium carbonate is added to the tank and comes to rest on the bottom wall of the tank at the media receiving side of the dosing device. The lip and curved baffle serve to prevent media falling into the delivery conduit until the rotor is actuated. Although not illustrated, the rotor has the same construction as that illustrated in WO2007/107322, with three axially aligned rotors each having a series of circumferential scooping pockets configured to pick up material from a media receiving side of the dosing device. Due to the disposition of the rotor with respect to the conduit and the bottom wall of the tank, rotation of the rotor results in media being scooped up and lifted upwards in the circumferential pockets and delivered from a product receiving side of the dosing device to a product delivery side where the product falls into the product delivery conduit and is delivered into the pressurised air supply line. Depending on the type of blasting operation required, the air pressure in the air supply line may be varied, and the amount of particulate product metered into the outlet may be varied by varying the speed of the rotor.

Compared with the blasting apparatus of the prior art, the apparatus of the invention allows the costs of manufacture and assembly to be reduced by simplifying the whole assembly. The dosing unit and the media are put into the same, evenly pressured enclosure allowing the walls and components to be thin and cheap, even made from soft plastic, because they will not endure high pressure gradients between inner and outer surfaces. In the prior art apparatus, the dosing unit and the tank are separated and connected through two pipes, one that allows the media to flow in the dosing unit and the other that allows balancing of the pressures between the dosing device and tank. With the apparatus of the invention, one conduit performs both roles. Moreover, as the dosing unit is now included in the tank, the pressure will be the same everywhere and the balancing of pressures is eased.

### EQUIVALENTS

The foregoing description details presently preferred embodiments of the present invention. Numerous modifications and variations in practice thereof are expected to occur to those skilled in the art upon consideration of these descriptions. Those modifications and variations are intended to be encompassed within the claims appended hereto.

1-15. (canceled)

16. A particulate material blasting apparatus comprising:
a particulate material dosing device;
a particulate material storage tank having a base, top and sidewalls and adapted to feed particulate material to the particulate material dosing device; and
a delivery conduit to deliver particular material into a pressurised gas line, the particulate material dosing device comprising a rotor comprising a series of scooping pockets mounted along a circumference of the rotor, the rotor configured to rotate to scoop-up particular material from a particulate material receiving side of the dosing device and deliver it up and around to a delivery side of the dosing device where it falls into the delivery conduit, wherein the particulate material dosing device is located in the particulate material storage tank and in which the delivery conduit comprises an upper part disposed within the particulate material storage tank having a first inlet aperture and a lower part disposed outside the particulate material storage tank having an outlet to deliver particular material into a pressurised gas line.

17. The particulate material blasting apparatus according to claim 16, in which the first inlet aperture is disposed adjacent the base of the particulate material storage tank, wherein the rotor is mounted partly within the first inlet aperture such that a particulate material receiving side of the rotor is disposed outside the aperture and a particulate material receiving side of the rotor is disposed inside the aperture.

18. The particulate material blasting apparatus according to claim 16, in which the upper part of the delivery conduit comprises a second inlet aperture disposed toward a top of the particulate material storage tank.

19. The particulate material blasting apparatus according to claim 16, including a baffle attached to the delivery conduit dimensioned to curve around and cover a top and sides of the particulate material receiving side of the rotor.

20. The particulate material blasting apparatus according to claim 16, including a bearing, gearbox and optionally a motor for the rotor, in which the bearing, gearbox and optionally the motor are contained within a sealed housing coupled to the base of the particulate material storage tank.

21. The particulate material blasting apparatus according to claim 16, in which the outlet is configured for fluidically coupling to a pressurised gas line.

22. The particulate material blasting apparatus according to claim 16, in which the top of the particulate material storage tank includes a fitting for receiving a top of the delivery conduit and securing the delivery conduit in position within the particulate material storage tank.

23. The particulate material blasting apparatus according to claim 16, in which a clearance between the rotor and the base of the particulate material storage tank is about 0.2 cm to about 0.6 cm.

24. The particulate material blasting apparatus according to claim 16, in which the rotor is mounted in the aperture of the delivery conduit such that an axle of the rotor is perpendicular with a longitudinal axis of the delivery conduit.

25. The particulate material blasting apparatus according to claim 16, in which the rotor is mounted in the aperture of the delivery conduit such that an axle of the rotor is in line with a sidewall of the delivery conduit.

26. The particulate material blasting apparatus according to claim 16, in which the delivery conduit and particulate material storage tank comprise a cylindrical pipe.

27. The particulate material blasting apparatus according to claim 16 and comprising at least two series of scooping pockets mounted along the circumference of the rotor, and in which the pockets of one series are circumferentially staggered with respect to the pockets of the other series.

28. The particulate material blasting apparatus according to claim 16 and comprising a plurality of rotors, in which the scooping pockets of one rotor are circumferentially staggered with respect to those of the other rotor(s).

29. The particulate material blasting apparatus according to claim 16, in which the pockets are formed by tooth-like formations which project from the circumference of the rotor.

30. A method of blasting a surface with particulate material which employs a particulate material blasting apparatus according to claim 16, which method comprises the steps of: providing a reservoir of particulate material in the particulate material storage tank; actuating a motor to rotate the rotor at a desired speed corresponding to the desired material dosing rate, and dosing particulate material through the delivery conduit into a pressurised gas line disposed externally to the storage reservoir; and blasting a surface by employing a nozzle fluidically coupled to the pressurised gas line to direct a stream of pressurised gas and particulate material at the surface.
